(19) United States
(12) Patent Application Publication
(10) Pub. No.: US 2014/0272390 A1
(43) Pub. Date: Sep. 18, 2014

(54) Low-E Panel with Improved Barrier Layer Process Window and Method for Forming the Same

(71) Applicant: INTERMOLECULAR INC., San Jose, CA (US)

(72) Inventors: Guowen Ding, San Jose, CA (US); Brent Boyce, Novi, MI (US); Minh Huu Le, San Jose, CA (US); Zhi-Wen Wen Sun, Sunnyvale, CA (US); Yu Wang, San Jose, CA (US)

(73) Assignee: INTERMOLECULAR INC., San Jose, CA (US)

(21) Appl. No.: 13/834,261

(22) Filed: Mar. 15, 2013

(51) Int. Cl. C03C 17/36

(52) U.S. Cl. CPC C03C 17/366; C03C 17/3615; C03C 17/3626
USPC 428/336; 427/164; 427/165; 427/166

(57) ABSTRACT

Embodiments provided herein describe low-e panels and methods for forming low-e panels. A transparent substrate is provided. A reflective layer is formed above the transparent substrate. A barrier layer is formed above the reflective layer. A nitride-containing layer is formed above the barrier layer. The nitride-containing layer has a thickness that is 1 nm or less. A over-coating layer is formed above the nitride-containing layer. The over-coating layer includes a different material than that of the nitride-containing layer.

The present invention relates to low-e panels. More particularly, this invention relates to low-e panels having an improved barrier layer process window and methods for forming such low-e panels.

### BACKGROUND OF THE INVENTION

Low emissivity, or low-e, panels are often formed by depositing a reflective layer (e.g., silver), along with various other layers, onto a transparent (e.g., glass) substrate. The various layers typically include various dielectric and metal oxide layers, such as silicon nitride, tin oxide, and zinc oxide, to provide a barrier between the stack and both the substrate and the environment, as well as to act as optical fillers and function as anti-reflective coating layers to improve the optical characteristics of the panel.

In recent years, the use of titanium in the “barrier layer,” often formed directly above the reflective layer, has been shown to provide desirable optical performance. However, in order to achieve this performance, the process steps used to form the titanium barrier layer must be performed very precisely. For example, while a precisely formed titanium barrier may demonstrate excellent optical performance, minor variations in the thickness of such a barrier layer may result in poor optical performance.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not necessarily to scale.

The techniques of the present invention can readily be understood by considering the following detailed description in conjunction with the accompanying drawings, in which:

FIG. 1 is a cross-sectional side view of a low-e panel according to some embodiments of the present invention.

FIG. 2 is a graph illustrating the series resistance of several low-e stacks at various barrier layer thicknesses.

FIG. 3 is a simplified cross-sectional diagram illustrating a physical vapor deposition (PVD) tool according to some embodiments of the present invention.

FIG. 4 is a flow chart illustrating a method for forming a low-e panel according to some embodiments of the present invention.

### DETAILED DESCRIPTION

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

Embodiments of the invention provide low-e optical coatings which provide an improved/increased process window while still allowing for optimal performance. In accordance with some embodiments of the invention, the “process window” for a titanium barrier layer is improved by forming a thin (e.g., 1 nm or less) nitride-containing layer (i.e., a process window enhancement layer) between the barrier layer and the over-coating layer. The use of the thin nitride-containing layer between the barrier layer and the over-coating layer allows for a greater range of thicknesses to be used for the barrier layer (e.g., by preventing oxygen from diffusing into the barrier layer), thus facilitating processing, as a larger processing window may used while still providing optimum performance.

In some embodiments, this nitride-containing layer is made of zinc nitride. In other embodiments, it is made of zinc oxynitride or another nitride/oxynitride with little or no absorption at visible wavelengths when deposited as a thin layer. The barrier layer may include titanium and be formed over the reflective layer, which is typically made of silver.

FIG. 1 illustrates a low-e panel 100 according to some embodiments of the present invention. The low-e panel 100 includes a transparent substrate 102 and a low-e stack 104 formed over (or above) the transparent substrate 102. The transparent substrate 102 in some embodiments is made of a low emissivity glass, such as borosilicate glass. However, in some embodiments, the transparent substrate 102 may be made of plastic or polycarbonate. The transparent substrate 102 has a thickness of, for example, between about 1 and about 10 millimeters (mm). In a testing environment, the transparent substrate 102 may be round with a diameter of, for example, about 200 or about 300 mm. However, in a manufacturing environment, the transparent substrate 102 may be square or rectangular and significantly larger (e.g., about 0.5—about 6 meters (m) across).

The low-e stack 104 includes a base layer 106, a seed layer 108, a reflective layer 110, a barrier layer 112, a process window enhancement layer 114, and an over-coating layer 116. Exemplary details as to the functionality provided by each of the layers 106-116 are provided below.

The various layers in the low-e stack 104 may be formed sequentially (i.e., from bottom to top) on the transparent substrate 102 using a physical vapor deposition (PVD) and/or reactive sputtering processing tool. In some embodiments, the low-e stack 104 is formed over the entire substrate 102. However, in other embodiments, the low-e stack 104 may only be formed on isolated portions of the transparent substrate 102. Although the layers may be described as being formed “above” or “over” the previous layer (or the substrate), it should be understood that in some embodiments, each layer is formed directly on (and adjacent to) the previously provided/formed component (e.g., layer). In other embodiments, additional layers may be included between the layers, and other processing steps may also be performed between the formation of various layers.

The base layer (or lower metal oxide layer) 106 is formed above the upper surface of the transparent substrate 102. The base layer 106 may be made of a metal oxide and have a thickness of, for example, approximately 150 Å. Examples of metal oxides used in the lower metal oxide layer 108 include, but are not limited to, titanium oxide, zinc oxide, tin oxide, and metal alloy oxides, such as zinc-tin oxide. The base layer 106 may be used to tune the optical properties of the low-e panel 100 as a whole, as well as to enhance silver nucleation.

The seed layer 108 is formed over the base layer 106. The seed layer 108 is made of a metal oxide and may have a thickness of, for example, approximately 100 Å. In some embodiments, the metal oxide used in the seed layer 108 is zinc oxide. The seed layer 108 may be used to enhance the deposition/growth of the reflective layer 110 on the low-e stack (e.g., enhance the crystalline structure and/or texturing of the reflective layer 110) and increase the transmission of the stack 104 for anti-reflection purposes. It should be understood that in other embodiments, the seed layer 108 may be made of tin oxide or may not be included at all.

The reflective layer 110 is formed above the seed layer 108. In some embodiments, the reflective layer 110 is made of silver and has a thickness of, for example, about 100 Å. As is commonly understood, the reflective layer 110 is used to reflect infra-red electro-magnetic radiation, thus reducing the amount of heat that may be transferred through the low-e panel 100.

The barrier layer 112 is formed over the reflective layer 110. In accordance with one aspect of the present invention, the barrier layer 24, in at least some embodiments, includes titanium (e.g., is made of titanium or titanium oxide). In some embodiments, the barrier layer 112 has a thickness of, for example, between 30 and 100 Å. The barrier layer 112 is used to protect the reflective layer 110 from the processing steps used to form the other, subsequent layers of the low-e stack 104 and to prevent any interaction of the material of the reflective layer 110 with the materials of the other layers of the low-e stack 104, which may result in undesirable optical characteristics of the Low-e panel 100.

According to one aspect of the present invention, the process window enhancement layer (or simply “enhancement layer”) 114 is formed over (e.g., adjacent to) the barrier layer 112. In some embodiments, the enhancement layer 114 comprises (i.e., is made of) a nitride, and as such may also be referred to as a “nitride-containing layer.” In some embodiments, the material used for the enhancement layer 114 does not include oxygen (e.g., is not an oxide). For example, in some embodiments, the enhancement layer 114 comprises (e.g., is made of) zinc nitride. In some embodiments, the enhancement layer 114 comprises an oxynitride, such as zinc oxynitride. The enhancement layer 114 may have a thickness that is not more (e.g., less than) 1.0 nanometers (nm), such as 0.5 nm. Other nitrides and oxynitrides with little or no absorption at visible wavelengths (at least when the thickness is 1 nm or less) may also be used, such as silicon nitride, tin nitride, aluminum nitride, titanium nitride, tantalum nitride, molybdenum nitride, and tungsten nitride. The enhancement layer 114 essentially performs the function of a second barrier layer as it protects the barrier layer 112 from any oxygen (or additional oxygen) which may otherwise diffuse from the layers above and adversely affect the performance of the low-e stack 104, while absorbing little, if any, visible light.

Still referring to FIG. 1, the over-coating layer (or upper metal oxide layer) 116 is formed over (e.g., and adjacent to) the enhancement layer 114 and may be made with the same material(s) as the base layer 106 (and does not include the same material as the barrier layer 112) and have a thickness of, for example, between 50 and 300 Å. Also like the lower metal oxide layer 108, the upper metal oxide layer may be used to further tune the optical properties of the low-e panel 100 as a whole.

Although not shown in FIG. 1, it should be understood that in some embodiments the low-e stack 104 may also include dielectric layers. One such layer (a lower dielectric layer) may be formed between the transparent substrate 102 and the base layer 106, while another (an upper dielectric layer) may be formed over the over-coating layer 116. These dielectric layers may, for example, be made of silicon nitride and have a thickness of about 250 Angstroms (Å). The lower of these layers may protect the other layers in the stack 104 from any elements which may otherwise diffuse from the substrate 102 and may be used to tune the optical properties (e.g., transmission) of the stack 104 and/or the low-e panel 100 as a whole, while the upper may be used to provide additional protection for the lower layers of the stack 104 and further adjust the optical properties of the stack 104. The upper dielectric layer may also be considered to be an over-coating layer (i.e., or a second over-coating layer).

It should be noted that depending on the materials used, some of the layers of the low-e stack 104 may have some materials in common. An example of such a stack may use a zinc-based material in the base layer 106, the seed layer 108, and the over-coating layer 116. As a result, embodiments described herein may allow for a relatively low number of different targets to be used for the formation of the low-e stack 104.

FIG. 2 graphically illustrates the sheet resistance (Rₛ) for low-e stacks using a conventional titanium barrier layer and a nickel-chromium barrier layer at various barrier layer thicknesses. As shown, the sheet resistance of the low-e stack using the nickel chromium is less affected by variations in the thickness of the barrier layer. The low-e stack using the titanium barrier layer has a lower sheet resistance at around 1.5 nm than that of the nickel chromium low-e stack at any thickness, but is drastically affected by any substantive increases in barrier layer thickness (e.g., a barrier layer thickness increase of 0.5 nm or more).

The methods described herein (e.g., the use of the process window enhancement layer described above) widens the process window for a titanium-based barrier layer such that it is similar to that of nickel chromium, while still providing the performance of titanium. For example, a low-e stack using a titanium-based barrier layer with the enhancement layer described above may allow for a variation in barrier layer thickness of as much as 4 nm without significantly affecting performance. Further, the enhancement layer allows for a thinner titanium-based barrier layer to be used by, for example, preventing oxygen diffusion from the over-coating layer. For example, when using a 1 nm thick titanium barrier layer, the sheet resistance of the stack may be as high as 34 ohms. However, the addition of the enhancement layer described above may reduce the sheet resistance of the stack to, for example, 10 ohms.

As such, the use of the barrier layer materials described herein allows for a greater range of thicknesses to be used for the barrier layer, thus facilitating processing, as a larger processing window may used while still providing acceptable performance. That is, the overall performance of the panel 100 may be improved as a wider range of barrier layer thickness may be utilized. As a result, manufacturing costs may be reduced.

FIG. 3 provides a simplified illustration of a physical vapor deposition (PVD) tool (and/or system) 300 which may be used to formed the low-e panel 10 and/or the low-e stack 104 described above, in accordance with some embodiments of the invention. The PVD tool 300 shown in FIG. 3 includes a housing 302 that defines, or encloses, a processing chamber 304, a substrate support 306, a first target assembly 308, and a second target assembly 310.

The housing 302 includes a gas inlet 312 and a gas outlet 314 near a lower region thereof on opposing sides of the substrate support 306. The substrate support 306 is positioned near the lower region of the housing 302 and is configured to support a substrate 316. The substrate 316 may be a round glass (e.g., borosilicate glass) substrate having a diameter of, for example, about 200 mm or about 300 mm. In some embodiments (such as in a manufacturing environment), the substrate 316 may have other shapes, such as square or rectangular, and may be significantly larger (e.g., about 0.5—about 6 m across). The substrate support 306 includes a support electrode 318 and is held at ground potential during processing, as indicated.

The first and second target assemblies (or process heads) 308 and 310 are suspended from an upper region of the housing 302 within the processing chamber 304. The first target assembly 308 includes a first target 320 and a first target electrode 322, and the second target assembly 310 includes a second target 324 and a second target electrode 326. As shown, the first target 320 and the second target 324 are oriented or directed towards the substrate 316. As is commonly understood, the first target 320 and the second target 324 include one or more materials that are to be used to deposit a layer of material 328 on the upper surface of the substrate 316.

The materials used in the targets 320 and 324 may, for example, include tin, zinc, magnesium, aluminum, lanthanum, yttrium, titanium, antimony, strontium, bismuth, silicon, silver, nickel, chromium, or any combination thereof (i.e., a single target may be made of an alloy of several metals). Additionally, the materials used in the targets may include oxygen, nitrogen, or a combination of oxygen and nitrogen in order to form the oxides, nitrides, and oxynitrides described above. Additionally, although only two targets 320 and 324 are shown, additional targets may be used.

The PVD tool 300 also includes a first power supply 330 coupled to the first target electrode 322 and a second power supply 332 coupled to the second target electrode 324. As is commonly understood, the power supplies 330 and 332 pulse direct current (DC) power to the respective electrodes, causing material to be, at least in some embodiments, simultaneously sputtered (i.e., co-sputtered) from the first and second targets 320 and 324.

During sputtering, inert gases, such as argon or krypton, may be introduced into the processing chamber 304 through the gas inlet 312, while a vacuum is applied to the gas outlet 314. However, in embodiments in which reactive sputtering is used, reactive gases may also be introduced, such as oxygen and/or nitrogen, which interact with particles ejected from the targets (i.e., to form oxides, nitrides, and/or oxynitrides), as may be the case with the formation of the titanium-yttrium oxide and yttrium oxide using in barrier layers in accordance with the embodiments described above.

Although not shown in FIG. 3, the PVD tool 300 may also include a control system having, for example, a processor and a memory, which is in operable communication with the other components shown in FIG. 3 and configured to control the operation thereof in order to perform the methods described herein.

Further, although the PVD tool 300 shown in FIG. 3 includes a stationary substrate support 306, it should be understood that in a manufacturing environment, the substrate 316 may be in motion during the various layers described herein.

FIG. 4 is a flow chart illustrating a method 400 for forming a low-e panel according to some embodiments of the present invention. The method 400 begins at block 402 by providing a transparent substrate such as the examples described above (e.g., glass).

At block 404, a reflective layer (e.g., silver) is formed above the transparent substrate. In some embodiments, the reflective layer is made of silver. At block 406, a barrier layer is formed above the reflective layer. In at least some embodiments, includes titanium. For example, the barrier layer may be made of titanium or titanium oxide.

At block 408, a nitride-containing layer (or process window enhancement layer) is formed above the barrier layer. In some embodiments, the nitride-containing layer comprises a nitride, such as zinc nitride, or an oxynitride, such as zinc oxynitride. As described above, the inclusion of the nitride-containing layer may widen the process window for a titanium-based barrier layer, such that it is more similar to that of nickel chromium.

At block 410, an over-coating layer is formed above the nitride-containing layer. In some embodiments, the over-coating layer is made of a material different than that of the nitride-containing layer (and is thus is distinct from the nitride-containing layer), such as a metal oxide. Although not shown in FIG. 4, additional processing may be performed, such as the formation of additional layers (e.g., dielectric layers).

Thus, in some embodiments, a method for forming a low-e panel is provided. A transparent substrate is provided. A reflective layer is formed above the transparent substrate. A barrier layer is formed above the reflective layer. A nitride-containing layer is formed above the barrier layer. The nitride-containing layer has a thickness that is 1 nm or less. An over-coating layer is formed above the nitride-containing layer. The over-coating layer includes a different material than that of the nitride-containing layer.

In some embodiments, a method for forming a low-e panel is provided. A transparent substrate is provided. A reflective layer is formed above the transparent substrate. A barrier layer is formed above the reflective layer. A nitride-containing layer is formed above and adjacent to the barrier layer. The nitride-containing layer includes zinc and has a thickness that is 1 nm or less. An over-coating layer is formed above the nitride-containing layer. The over-coating layer includes a different material than that of the nitride-containing layer.

In some embodiments, a low-e panel is provided. The low-e panel includes a transparent substrate. A reflective layer is formed above the transparent substrate. A barrier layer is formed above the reflective layer. A nitride-containing layer is formed above the barrier layer. The nitride-containing layer has a thickness that is 1 nm or less. A over-coating layer is formed above the nitride-containing layer. The over-coating layer includes a different material than that of the nitride-containing layer.

Although the foregoing examples have been described in some detail for purposes of clarity of understanding, the invention is not limited to the details provided. There are many alternative ways of implementing the invention. The disclosed examples are illustrative and not restrictive.

What is claimed:

1. A method for forming a low-e panel, the method comprising:
providing a transparent substrate;
forming a reflective layer above the transparent substrate;
forming a barrier layer above the reflective layer;
forming a nitride-containing layer above the barrier layer, the nitride-containing layer having a thickness that is 1 nm or less; and
forming an over-coating layer above the nitride-containing layer, the over-coating layer comprising a different material than that of the nitride-containing layer.

2. The method of claim 1, wherein the nitride-containing layer comprises zinc.

3. The method of claim 2, wherein the nitride-containing layer comprises zinc-oxynitride.

4. The method of claim 2, wherein the barrier layer comprises titanium.

5. The method of claim 4, wherein the over-coating comprises an oxide, a nitride, or an oxynitride.

6. The method of claim 5, wherein the over-coating layer has a thickness of between 50 and 300 Å.

7. The method of claim 1, wherein the reflective layer comprises silver.

8. The method of claim 7, wherein the transparent substrate comprises glass.

9. The method of claim 1, wherein the nitride-containing layer is formed adjacent to the barrier layer.

10. The method of claim 9, wherein the barrier layer is formed adjacent to the reflective layer.

11. A method for forming a low-e panel, the method comprising:
providing a transparent substrate;
forming a reflective layer above the transparent substrate;
forming a barrier layer above the reflective layer;
forming a nitride-containing layer above and adjacent to the barrier layer, the nitride-containing layer comprising zinc and having a thickness that is 1 nm or less; and
forming an over-coating layer above the nitride-containing layer, the over-coating layer comprising a different material than that of the nitride-containing layer.

12. The method of claim 11, wherein the transparent substrate comprises glass.

13. The method of claim 12, wherein the reflective layer comprises silver.

14. The method of claim 13, wherein the barrier layer is formed adjacent to the reflective layer.

15. The method of claim 14, wherein at least some of the reflective layer, the barrier layer, the nitride-containing layer, and the over-coating layer are formed using physical vapor deposition (PVD).

16. A low-e panel comprising:
a transparent substrate;
a reflective layer formed above the transparent substrate;
a barrier layer formed above the reflective layer;
a nitride-containing layer formed above the barrier layer, the nitride-containing layer having a thickness that is 1 nm or less; and
an over-coating layer formed above the nitride-containing layer, the over-coating layer comprising a different material than that of the nitride-containing layer.

17. The low-e panel of claim 16, wherein the nitride-containing layer comprises zinc.

18. The low-e panel of claim 17, wherein the nitride-containing layer comprises zinc-oxynitride.

19. The low-e panel of claim 18, wherein the nitride-containing layer is adjacent to the barrier layer.

20. The low-e panel of claim 19, wherein the barrier layer is adjacent to the reflective layer.
